(19) United States
(12) Patent Application Publication
(10) Pub. No.: US 2009/0057212 A1
(43) Pub. Date: Mar. 5, 2009

(54) TREATMENT SYSTEM OF LOW CONCENTRATION SANITARY SEWAGE

(75) Inventor: Qingmei LI, Beijing (CN)

Correspondence Address: YING CHEN;Chen Yoshimura LLP, 255 S. GRAND AVE., # 215, LOS ANGELES, CA, 90012, US

(73) Assignee: BEIJING NENGTUO HIGH TECHNOLOGY CO., LTD, Beijing (CN)

(21) Appl. No.: 11/963,987

(22) Filed: Dec. 24, 2007

(30) Foreign Application Priority Data
Aug. 27, 2007 (CN) 200710120782.2

(51) Int. Cl. C02F 9/14; C02F 9/00; C02F 9/02

(52) U.S. Cl. 210/87; 210/202; 210/85; 210/173; 210/101

(57) ABSTRACT

This invention relates to a treatment system of low concentration sanitary sewage, mainly comprising a primary filtering device, a cyclone separator assembly and an aerobic biochemical treatment fluidized bed. The primary filtering device, cyclone separator assembly and aerobic biochemical fluidized are connected orderly. The primary filtering device is composed of several filtering modules, the cyclone separator assembly is composed of several cyclone separators, and the aerobic biological treatment fluidized bed is composed of several aerobic biochemical treatment modules. Such a system is suitable for small-scale and low-concentration sanitary sewage treatment, which has the advantages of good treatment effect, compact structure, flexible installation and small land used.

### TECHNICAL FIELD

This invention relates to the technical field of environmental protection, and more particularly, to a treatment system of low concentration sanitary sewage.

### BACKGROUND

With the application of the separating collection and discharge mode of the sanitary sewage source, the sanitary sewage will be divided into two categories: one category is high concentration sanitary sewage from toilets with the main contamination derived from W.C. pan, the concentration of which is very high and need to be treated by specialized treatment system. The other is the general biochemical sewage, which is characterized by low concentration contamination and can come up to the standard of the sewage reuse as long as after simple treatment. The present sanitary sewage miniaturization treatment system aims at the existing mixed collection and discharge of the sanitary sewage and the concentration of the mixed sanitary sewage is between the high concentration source separation sanitary sewage and the low concentration sanitary sewage, which is not suitable for the treatment of low concentration sanitary sewage from the economical point. Because the present miniaturization treatment system is mainly the engineering structure with the large civil engineering, the large occupation of land and the large amount of investment, it is necessary to develop a treatment system with simple structure to adapt to low concentration sewage after source separation.

### SUMMARY

To overcome the above disadvantages of the existing technology, the present invention provides a treatment system of low concentration sanitary sewage. Such a system is suitable for small-scale and low-concentration sanitary sewage treatment, which has advantages of good treatment effect, compact structure, flexible installation and small land used.

To achieve the above purposes, the present invention uses the following technical solution: a treatment system of low concentration sanitary sewage mainly comprises a primary filtering device, a cyclone separator assembly and an aerobic biochemical treatment fluidized bed. The primary filtering device, cyclone separator and aerobic biochemical fluidized are connected orderly. The primary filtering device is composed of several filtering modules, the cyclone separator assembly is composed of several cyclone separators, and the aerobic biological treatment fluidized bed is composed of several aerobic biochemical treatment modules.

Since the whole flow of treatment designed in present invention is reasonable, using the aerobic treatment way with high quality water, which can effectively eliminate low concentration BOD and COD, it is suitable for the low concentration sanitary sewage treatment with good treatment effect. Since it realizes the modularization of the treatment system, the number of treatment modules can be increased or reduced as required, and the parallel series relation between the various modules is flexible to form different flow way, the reasonable treatment time of each process is ensured; This modularization design is in favor of the equipment manufacture and processing in order to reduce the manufacture cost, facilitate the construction and maintenance, then low the investment and maintenance cost; After the sanitary sewage is treated by the present system, it can be directly used as landscape water, irrigation water, etc. And the water recycling is realized without the need for other dilution water sources as well as self-contained reservoirs and the need for centralized water treatment plant with high investment and larger occupation of land, also corresponding diversion and drainage pipeline system is omitted. This unitized control scheme with the characteristics of extensive scope of application and mobile flexible installation can adapt to ever changeful sewage discharge conditions and sewage sources produced continuously.

### BRIEF DESCRIPTION OF THE DRAWINGS

The accompanying drawings, which are incorporated in and constitute a part of specification, illustrate an exemplary embodiment of the present invention and, together with the general description given above and the detailed description of the preferred embodiment given below, serve to explain the principles of the present invention.

FIG. 1 is a structure schematic diagram of the present invention.

### DETAILED DESCRIPTION

While the claims are not limited to the illustrated embodiments, an appreciation of various aspects of the present invention is best gained through a discussion of various examples thereof. Referring now to the drawings, illustrative embodiments will be described in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

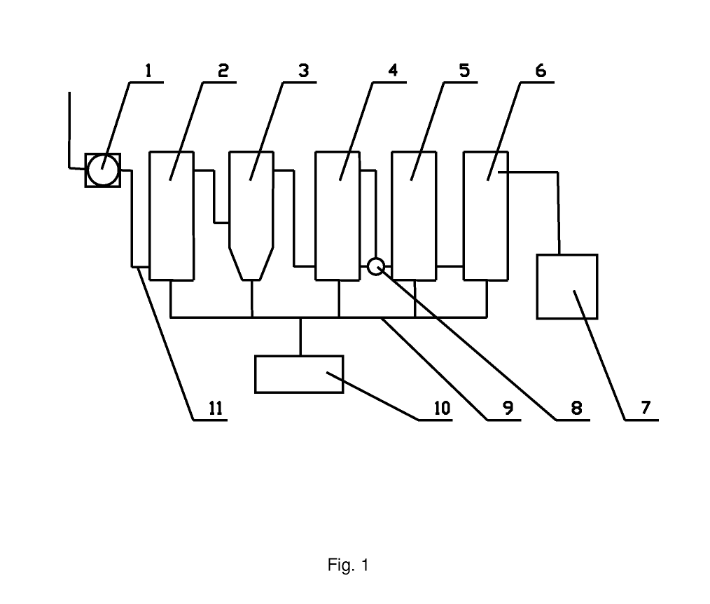

With reference to FIG. 1, this invention provides a treatment system of low concentration sanitary sewage, mainly comprising the primary filtering device 2, cyclone separator assembly 3 and aerobic biochemical treatment fluidized bed 4. The said primary filtering device, cyclone separator assembly and aerobic biochemical treatment fluidized bed are connected orderly. The primary filtering device is composed of several filtering modules, the cyclone separator assembly is composed of several cyclone separators, and the aerobic biological treatment fluidized bed is equipped with several aerobic biochemical treatment modules.

The said primary filtering device mainly filters oversize solids in the sewage with the standardized designed filtering modules through which the optimal separating effect can be realized. When the quantity of treated sewage changes, the filtering modules can be connected in parallel as required to ensure filtering effect and resistance requirement. The filtering modules can adopt a filter screen structure and the filter screen is fixedly installed on the filter screen frame, a number of which are coordinately installed on the primary filtering device to form an effective filtering surface.

Since the main pollutants in the low concentration sanitary sewage are BOD and COD, the aerobic biochemical treatment approach, which has good treatment effect and is suitable for the advanced treatment of the low concentration sewage, is adopted to ensure the purification level of effluent, so as to come up to the standard of the reclaimed water reuse. The biochemical reaction device, which is economical and effective, is suitable for China's national condition and can solve BOD/COD problems. To save the land occupation, the form of the circulating fluidized bed is adopted with small land occupation area (square meter order of magnitude), far greater treatment quantity of unit volume than that of the usual sewage treatment equipment and relatively short sewage residence time. The aerobic fluidized bed employs modularization design which is composed of several aerobic biological treatment modules. Each module comprises a frame or case body and the corresponding padding or filtering membrane fixed by the frame or case body. According to the treatment quantity and the concentration of the sewage, waterpower residence time of the sewage is determined and the required number of modules under a certain water flow is calculated. Then the modules are installed on the fluidized bed, and the fluidized bed temperature, oxygen content and other technological parameters are regulated by a self-contained blower fan and a heater. Several corresponding sensors and central control system are set up to realize real-time monitoring of these technical parameters.

The outlet piping of the aerobic fluidized bed is equipped with the three-way shunting valve 8. The shunting valve has two outlets and can adjust the effluent proportion of each outlet, and one outlet connects with succeeding pipe (such as the inlet pipes of the succeeding settling tanks or other treatment equipments), and the other outlet connects with the water inlet of the fluidized bed itself, whereby reflux can be carried out to realize multiple circulating treatment so as to improve treatment efficiency as required. The design of such shunting valve can easily adjust the reflux rate and it is very flexible to be used.

A settling tank 5 is connected with the back of the aerobic biological treatment fluidized bed to settle the sludge generated from the aerobic treatment. According to need, the sludge reflux pipeline can be equipped to connect with the sludge reflux outlet of the settling tank and the inlet of the aerobic fluidized bed so as to realize sludge reflux.

The back of the settling tank is equipped with the sterilizing device 6 with several sterilizing modules. Each sterilizing module can use an ozone sterilizing module, an electrolytic metal ions sterilizing module or a chemical sterilizing module as required. The sterilizing device is equipped with a certain number of sterilizing modules as required to realize modularization of the sterilizing device, also realize standardized design of the sterilizing modules.

The front of the primary filtering device can be equipped with the smashing device 1 so that the impurities in the sewage are smashed so as to meet the succeeding treatment requirements.

The cyclone separator assembly, the aerobic biological treatment fluidized bed, the settling tank and the sterilizing device are all equipped with sludge outlets connecting to sludge pool 10 through sludge pipe 9 for centralized treatment.

The said parts connect with each other through sewage pipeline 11 and are all equipped with the corresponding pumps so as to provide power for the flow of the sewage and sludge.

The reclaimed water reservoir 7 is set after the settling tank or sterilizing device according to the present system so as to collect the discharged water after treatment for the utilization of the reclaimed water.

The present system is not a civil engineering-type but an equipment-type system, namely each part uses the steel structure frame or chassis, and only the base needs civil engineering with small civil engineering quantity and very convenient construction. And modularization design will enable all modules with standardization design and be in optimum structure and optimal operation environment so as to achieve the perfect effect. Once the module is designed, the workload of the specific engineering design is very small. As long as according to the quantity of sewage and the inlet and outlet concentration of the sewage, the purification efficiency and the number of modules of each part are calculated, which greatly facilitate practical generalization and utilization.

The advantages of the present system are as follows:

(1) The present system complies with the logos of collection and treatment for the sanitary sewage source separation, aims at effectively treatment of the low concentration sanitary sewage which is difficult to resolve using existing technologies so as to on the spot process and utilize, greatly reduces the land occupation of the sewage pipes and solves the sewage treatment problems of small-scale sewage sources. This system and the traditional centralized processing systems characterized by civil engineering are complementary with each other. This system can vary according to different situations to use the discrete compact control system characterized by the equipment, processes the dispersed pollution sources on the spot without additional and high investment centralized water treatment plants, saving a lot of expense and land resources and will be able to duly deal with emerging new pollution sources.

(2) Owing to the advantages of the flexibility for setup, high efficiency, strong pertinence and updating, saving investment and small land occupation, etc., the system can carry out the stage treatment of sewage in partial location and realize the water regeneration, classification or duty-cycle operation so that one water can be used for different applications to improve the efficacy of water usage and reduce the discharge of pollution.

(3) In city, it can provide the economical circulating water system for the residential area, swimming pool, spa bath, ornamental water utilization, car washing, fishing and many other places, drastically reducing the quantity of replenishing water and sewage discharge in these regions. It can save a lot of funds due to its low equipment cost than other treatment schemes and can be easily accepted by factories who produce pollution so that pollution producers can economically and efficiently deal with the self-pollution.

(4) For the villages and towns and remote areas without qualification to establish large-scale sewage treatment plant, an appropriate combination can be employed according to local conditions to form sewage treatment equipment suitable for local conditions, increasing operationally effective water sources. At the same time, it can be used for purifying rivers and lakes and sewage drains, sanitary sewage treatment, feces and urine treatment in stock farm, and so on;

(5) To help to change existing environmental protection engineering model designed and constructed respectively according to specific items to form a new type of environmental protection industry and bring environmental and economic benefits.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A treatment system of low concentration sanitary sewage, mainly comprising a primary filtering device, a cyclone separator assembly and an aerobic biochemical treatment fluidized bed, and the primary filtering device, cyclone separator assembly and aerobic biochemical fluidized are connected orderly, the primary filtering device is composed of several filtering modules, the cyclone separator assembly is composed of several cyclone separators, and the aerobic biological treatment fluidized bed is composed of several aerobic biochemical treatment modules.

2. The treatment system of low concentration sanitary sewage as claimed in claim 1, wherein several corresponding sensors and central control system are set up for the real-time monitoring of technical parameters.

3. The treatment system of low concentration sanitary sewage as claimed in claim 2, wherein the filtering module of the primary filtering device is designed as standardized filter screen structure and the filter screen is fixedly installed on the filter screen frame, a number of which are coordinately installed on the primary filtering device to form an effective filtering surface.

4. The treatment system of low concentration sanitary sewage as claimed in claim 3, wherein the outlet piping of the aerobic fluidized bed is equipped with an three-way shunting valve, which has two outlets and can adjust the effluent proportion of each outlet, one outlet connecting with succeeding pipe and the other connecting with the water inlet of the fluidized bed itself.

5. The treatment system of low concentration sanitary sewage as claimed in claim 4, wherein a settling tank is connected with the back of the aerobic biological treatment fluidized bed.

6. The treatment system of low concentration sanitary sewage as claimed in claim 5, wherein the back of the settling tank is equipped with a sterilizing device provided with several sterilizing modules, and each sterilizing module adopts ozone sterilizing module, electrolyzlic metal ions sterilizing module or chemical sterilizing module.

7. The treatment system of low concentration sanitary sewage as claimed in claim 6, wherein a smashing device is set in front of the primary filtering device.

8. The treatment system of low concentration sanitary sewage as claimed in claim 7, wherein the cyclone separator assembly, aerobic biological treatment fluidized bed, settling tank and sterilizing device are equipped with sludge outlets connected to sludge pool through sludge pipes.

9. The treatment system of low concentration sanitary sewage as claimed in claim 7, wherein the respective parts are connected with each other through waste pipes and equipped with the corresponding pumps, and the reclaimed water reservoir is located on the back of the settling tank or sterilizing device.

10. The treatment system of low concentration sanitary sewage as claimed in claim 1, wherein the filtering module of the primary filtering device is designed as standardized filter screen structure and the filter screen is fixedly installed on the filter screen frame, a number of which are coordinately installed on the primary filtering device to form an effective filtering surface.

11. The treatment system of low concentration sanitary sewage as claimed in claim 10, wherein the outlet pipe of the aerobic fluidized bed is equipped with an three-way shunting valve in which there are two outlets regulating the ratio of water from each water outlet, one connecting with succeeding pipe, the other connecting with the water inlet of the fluidized bed.

12. The treatment system of low concentration sanitary sewage as claimed in claim 11, wherein a settling tank is connected with the back of the aerobic biological treatment fluidized bed.

13. The treatment system of low concentration sanitary sewage as claimed in claim 12, wherein the back of the settling tank is equipped with a sterilizing device with several sterilizing modules, and each sterilizing module is ozone sterilizing, electrolytic metal ions sterilizing or chemical sterilizing module.

14. The treatment system of low concentration sanitary sewage as claimed in claim 13, wherein a smashing device is set in the front of the primary filtering device.

15. The treatment system of low concentration sanitary sewage as claimed in claim 14, wherein the cyclone separator assembly, aerobic biological treatment fluidized bed, settling tank and sterilizing device are all equipped with sludge outlets connecting with sludge pool through sludge pipes.

16. The treatment system of low concentration sanitary sewage as claimed in claim 15, wherein the said parts are connected with each other through sewage pipes and are equipped with the corresponding pumps respectively.

17. The low treatment system concentration sanitary sewage as claimed in claim 16, wherein the reclaimed water reservoir is set after the settling tank or sterilizing device
